(19) United States
(12) Patent Application Publication
(10) Pub. No.: US 2024/0222998 A1
(43) Pub. Date: Jul. 4, 2024

(54) ELECTRONIC DEVICE COMPRISING PLURALITY OF BATTRIES, AND OPERATING METHOD THEREFOR

(71) Applicant: SAMSUNG ELECTRONICS CO., LTD., Suwon-si (KR)

(72) Inventors: Sungyong KIM, Suwon-si (KR); Kisun LEE, Suwon-si (KR)

(21) Appl. No.: 18/610,799

(22) Filed: Mar. 20, 2024

Related U.S. Application Data
(63) Continuation of application No. PCT/KR2022/013159, filed on Sep. 2, 2022.

(30) Foreign Application Priority Data
Nov. 3, 2021 (KR) 10-2021-0149386
Dec. 9, 2021 (KR) 10-2021-0176021

(51) Int. Cl. H02J 7/00

(52) U.S. Cl. CPC H02J 7/007182; H02J 7/0049

(57) ABSTRACT

An electronic device according to various embodiments may comprise: a plurality of batteries; a charging circuit configured to charge the batteries; a first circuit configured to: the voltage of each battery so as to acquire voltage values of the respective batteries, and transmit one of the acquired voltage values to the charging circuit; and at least one processor, comprising processing circuitry, individually and/or collectively, configured to control the first circuit. At least one processor, individually and/or collectively may be configured to: control the first circuit so that the first circuit transmits, to the charging circuit, a maximum voltage value from among first voltage values of the respective batteries, based on the first voltage values of the respective batteries, acquired by the first circuit, exceeding a first threshold voltage value, determine whether the batteries have been fully charged, select one of the batteries that have not been fully charged based on some of the batteries not being fully charged, and control the first circuit to transmit, to the charging circuit, a second voltage value of the battery selected by the first circuit from among second voltage values of the respective batteries, acquired by the first circuit.

### CROSS-REFERENCE TO RELATED APPLICATIONS

This application is a continuation of International Application No. PCT/KR2022/013159 designating the United States, filed on Sep. 2, 2022, in the Korean Intellectual Property Receiving Office and claiming priority to Korean Patent Application Nos. 10-2021-0149386, filed on Nov. 3, 2021, and 10-2021-0176021, filed on Dec. 9, 2021, in the Korean Intellectual Property Office, the disclosures of each of which are incorporated by reference herein in their entireties.

### BACKGROUND

### Field

The disclosure relates to an electronic device including a plurality of batteries.

### Description of Related Art

An electronic device may include and charge a plurality of batteries. The electronic device may monitor voltage information of one of the batteries and may perform charge control using the voltage information. The voltage information used for the charge control may include a false voltage due to direct current resistance and thus may be different from the actual voltage of a battery.

Typical charging circuits may structurally monitor voltage information of one of a plurality of batteries and may not readily monitor the voltage information of each battery. The typical charging circuits may charge a battery that is not monitored using the voltage information of a battery that is monitored. For example, when there are a fully charged battery and a not fully charged battery among the batteries, the typical charging circuits may additionally charge the not fully charged battery using the voltage information of the fully charged battery. In addition, when some of the batteries require to be recharged, the typical charging circuits may recharge the batteries that require to be recharged using the voltage information of batteries that do not require to be recharged. The typical charging circuits may perform additional charging or recharging using inaccurate voltage information.

In addition, the voltage information of the battery that is monitored by the typical charging circuits may be greater than the actual voltage of the battery because the voltage information includes a false voltage due to direct current resistance, and a charging time may increase because a constant voltage (CV) charging section increases.

An electronic device including a plurality of batteries may require charge/discharge control of each battery based on the state of each battery.

### SUMMARY

Embodiments of the disclosure may provide an electronic device for selecting a voltage value of one of a plurality of batteries depending on conditions (or states) and perform charging (charge control) when charging the batteries.

Embodiments of the disclosure may provide an electronic device for performing additional charging or recharging on an individual battery depending on the state of the individual battery.

Embodiments of the disclosure may provide an electronic device for performing charging (or charge control) using a voltage value without a false voltage or with a minimized and/or reduced false voltage.

The technical goals to be achieved are not limited to those described above, and other technical goals not mentioned above are clearly understood by one of ordinary skill in the art from the following description.

An electronic device according to various example embodiments includes: a plurality of batteries, a charging circuit configured to charge the batteries, a first circuit configured to: sense a voltage of each of the batteries; obtain respective voltage values of the batteries; and relay one of the obtained voltage values to the charging circuit, and at least one processor, comprising processing circuitry, individually and/or collectively, configured to: control the first circuit; based on respective first voltage values, obtained by the first circuit, of the batteries exceeding a first threshold voltage value, control the first circuit to relay a maximum voltage value among the respective first voltage values of the batteries to the charging circuit, determine whether the batteries are fully charged, based on some of the batteries not being fully charged, select one of the batteries that are not fully charged, and control the first circuit to relay a second voltage value of the selected battery among respective second voltage values, obtained by the first circuit, of the batteries to the charging circuit. The charging circuit is further configured to: determine a first charging current value based on the maximum voltage value and charge the batteries in a first charging mode, based on the determined first charging current value.

The electronic device according to various example embodiments includes: a plurality of batteries, a charging circuit configured to charge the batteries, a first circuit configured to: relay a minimum voltage value among respective first voltage values obtained by sensing respective voltages of the batteries in a first mode to the charging circuit, relay a maximum voltage value among respective second voltage values obtained by sensing the respective voltages of the batteries in a second mode to the charging circuit, and relay a third voltage value of a battery selected by at least one processor, comprising processing circuitry, from among respective third voltage values obtained by sensing the respective voltages of the batteries in a third mode to the charging circuit, wherein at least one processor, individually and/or collectively, is configured to: based on respective initial voltage values, obtained by the first circuit, of the batteries exceeding a first threshold voltage value, control the first circuit to operate in the second mode, determine whether the batteries are fully charged, based on some of the batteries not being fully charged, select one battery that is not fully charged, and control the first circuit to operate in the third mode. Base on one or more of the respective initial voltage values being less than or equal to the first threshold voltage value, the first circuit is further configured to operate in the first mode.

A method of operating an electronic device according to various example embodiments includes: based on respective initial voltage values of batteries obtained by a first circuit in the electronic device exceeding a first threshold voltage value, controlling the first circuit to operate in a second mode among a first mode, the second mode, and a third mode, determining whether the batteries are fully charged, based on some of the batteries not being fully charged, selecting one of the batteries that are not fully charged, and controlling the first circuit to relay a second voltage value of the selected battery among respective second voltage values, obtained by the first circuit, of the batteries to the charging circuit.

An electronic device according to various example embodiments may select a voltage value of one of a plurality of batteries depending on conditions (or states) and may perform charging (charge control) when charging the batteries, and thus may improve charging safety.

The electronic devices according to various example embodiments may perform additional charging or recharging depending on the state of an individual battery, and thus may improve the charging safety of the individual battery.

The electronic devices according to various example embodiments may perform charging (or charge control) using a voltage value without a false voltage or with a minimized and/or reduced false voltage, and thus may reduce a charging time.

In addition, various effects directly or indirectly ascertained through the present disclosure may be provided.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment, according to various embodiments;

FIG. 2 is a block diagram illustrating an example configuration of a power management module and a battery, according to various embodiments;

FIG. 3 is a block diagram illustrating an example configuration of an electronic device, according to various embodiments;

FIG. 4 is a diagram illustrating an example of a circuit configuration of an electronic device, according to various embodiments;

FIG. 5 is a diagram illustrating an example of a first circuit in an electronic device, according to various embodiments;

FIG. 6 is a flowchart illustrating an example charging operation of an electronic device, according to various embodiments; and

FIG. 7 is a flowchart illustrating an example operating method of an electronic device, according to various embodiments.

### DETAILED DESCRIPTION

Hereinafter, various example embodiments will be described in greater detail with reference to the accompanying drawings. When describing the example embodiments with reference to the accompanying drawings, like reference numerals may refer to like elements and a repeated description related thereto may not be provided.

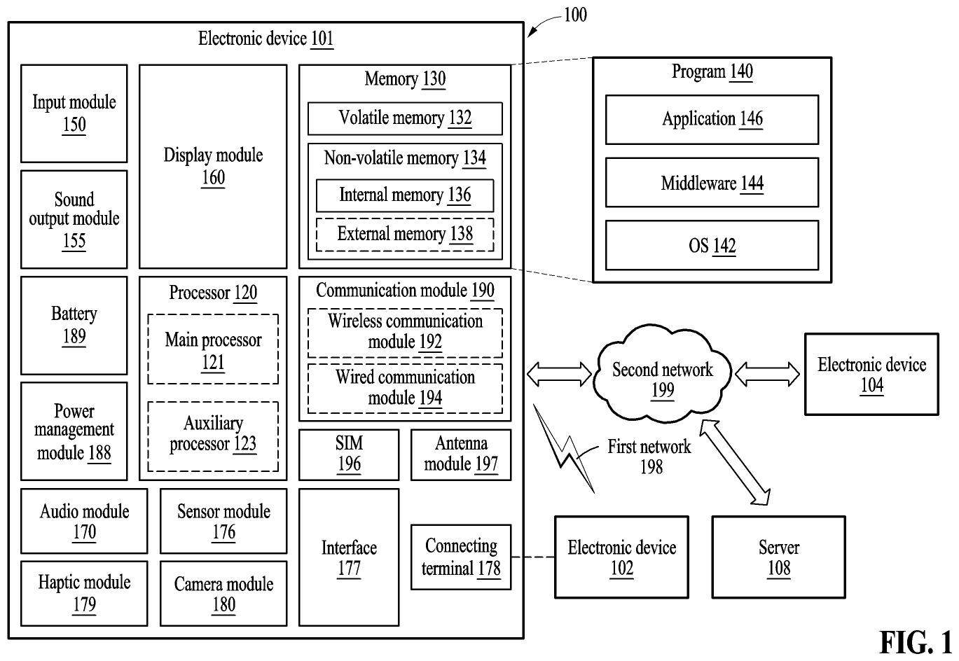

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network) or communicate with at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one (e.g., the connecting terminal 178) of the above components may be omitted from the electronic device 101, or one or more other components may be added in the electronic device 101. In various examples, some (e.g., the sensor module 176, the camera module 180, or the antenna module 197) of the components may be integrated as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 connected to the processor 120 and may perform various data processing or computation. According to an embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An AI model may be generated by machine learning. The machine learning may be performed by, for example, the electronic device 101, in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network BRDNN), and a deep Q-network or a combination of two or more thereof but is not limited thereto. The AI model may additionally or alternatively include a software structure other than the hardware structure.

The memory 130 may store various pieces of data used by at least one component (e.g., the processor 120 or the sensor module 176) of the electronic device 101. The various pieces of data may include, for example, software (e.g., the program 140) and input data or output data for a command related thereto. The memory 130 may include the volatile memory 132 or the non-volatile memory 134.

The program 140 may be stored as software in the memory 130 and may include, for example, an operating system (OS) 142, middleware 144, or an application 146.

The input module 150 may receive, from outside (e.g., a user) the electronic device 101, a command or data to be used by another component (e.g., the processor 120) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing a recording. The receiver may be used to receive an incoming call. According to an embodiment, the receiver may be implemented separately from the speaker or as a portion of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to sense a touch, or a pressure sensor adapted to measure an intensity of a force incurred by the touch. The display module 160 may be implemented with, for example, a foldable structure and/or a rollable structure. For example, a size of a display screen of the display module 160 may be reduced when folded and expanded when unfolded.

The audio module 170 may convert a sound into an electric signal and vice versa. According to an embodiment, the audio module 170 may obtain the sound via the input module 150 or output the sound via the sound output module 155 or an external electronic device (e.g., an electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101 and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may physically connect to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus, which may be recognized by a user via their tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a portion of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., an antenna array). In such a case, at least one antenna appropriate for a communication scheme used in a communication network, such as the first network 198 or the second network 199, may be selected by, for example, the communication module 190 from the antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed by the electronic device 101 may be executed at one or more external electronic devices (e.g., the external electronic devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least portion of the function or the service. The one or more external electronic devices receiving the request may perform the at least part of the function or service, or an additional function or an additional service related to the request and may transfer a result of the performance to the electronic device 101. The electronic device 101 may provide the result, with or without further processing the result, as at least part of a response to the request. To that end, cloud computing, distributed computing, mobile edge computing (MEC), or client-server computing technology may be used, for example. The electronic device 101 may provide ultra low-latency services using, e.g., distributed computing or MEC. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

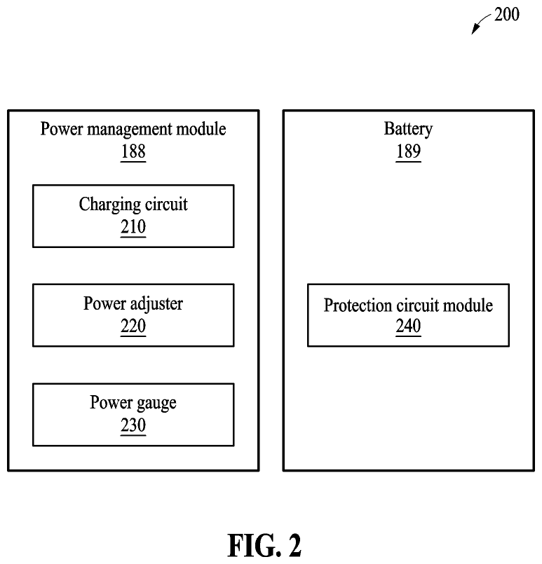

FIG. 2 is a block diagram 200 illustrating an example configuration of a power management module 188 and a battery 189, according to various embodiments.

Referring to FIG. 2, the power management module 188 may include a charging circuit 210, a power adjuster (e.g., including various circuitry and/or executable program instructions) 220, and/or a power gauge (e.g., including various circuitry and/or executable program instructions) 230. The charging circuit 210 may charge the battery 189 using power supplied from an external power source outside the electronic device 101. According to an embodiment, the charging circuit 210 may select a charging scheme (e.g., normal charging or quick charging) based at least in part on the type of the external power source (e.g., a power outlet, a USB, or wireless charging), a magnitude of power suppliable from the external power source (e.g., about 20 Watts or more), or an attribute of the battery 189, and may charge the battery 189 using the selected charging scheme. The external power source may be connected to the electronic device 101, for example, directly via the connecting terminal 178 or wirelessly via the antenna module 197.

The power adjuster 220 may generate a plurality of powers having different voltage levels or different current levels by adjusting a voltage level or a current level of the power supplied from the external power source or the battery 189. The power adjuster 220 may adjust the voltage level or the current level of the power supplied from the external power source or the battery 189 into a different voltage level or current level appropriate for each of some of the components included in the electronic device 101. According to an embodiment, the power adjuster 220 may be implemented in the form of a low-dropout (LDO) regulator or a switching regulator. The power gauge 230 may measure use state information about the battery 189 (e.g., the capacity, the number of times charging or discharging, voltage, or the temperature of the battery 189).

The power management module 188 may determine, using, for example, the charging circuit 210, the power adjuster 220, and/or the power gauge 230, charging state information (e.g., lifespan, over voltage, low voltage, over current, over charge, over discharge, overheat, short, or swelling) related to the charging of the battery 189 based at least in part on the measured use state information about the battery 189. The power management module 188 may determine whether the state of the battery 189 is normal or abnormal based at least in part on the determined charging state information. If the state of the battery 189 is determined to be abnormal, the power management module 188 may adjust charging the battery 189 (e.g., reduce the charging current or voltage, or stop the charging). According to an embodiment, at least some of the functions of the power management module 188 may be performed by an external control device (e.g., the processor 120).

According to an embodiment, the battery 189 may include a protection circuit module (PCM) (e.g., including various circuitry and/or executable program instructions) 240. The PCM 240 may perform one or more of various functions (e.g., a pre-cutoff function) to prevent and/or reduce performance deterioration of or damage to the battery 189. The PCM 240, additionally or alternatively, may be configured as at least part of a battery management system (BMS) capable of performing various functions including cell balancing, measurement of battery capacity, count of the number of charging or discharging, measurement of temperature, or measurement of voltage.

According to an embodiment, at least part of the charging state information or use state information regarding the battery 189 may be measured using a corresponding sensor (e.g., a temperature sensor) of the sensor module 176, the fuel gauge 230, or the power management module 188. According to an embodiment, the corresponding sensor (e.g., the temperature sensor) of the sensor module 176 may be included as part of the PCM 240 or may be disposed near the battery 189 as a separate device.

The electronic devices according to various example embodiments may be various types of electronic devices. The electronic device may include, for example, a portable communication device (e.g., a smartphone), a computer device, a portable multimedia device, a portable medical device, a camera, a wearable device, a home appliance device, or the like. According to an embodiment, the electronic device is not limited to those described above.

It should be understood that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question and may refer to components in other aspects (e.g., importance or order) is not limited. It is to be understood that if a component (e.g., a first component) is referred to, with or without the term “operatively” or “communicatively”, as “coupled with”, “coupled to”, “connected with”, or “connected to” another component (e.g., a second component), the component may be coupled with the other component directly (e.g., by wire), wirelessly, or via a third component.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101 of FIG. 1). For example, a processor (e.g., the processor 120) of the machine (e.g., the electronic device 101) may invoke at least one of the one or more instructions stored in the storage medium and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)) or may be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to an embodiment, the integrated component may still perform one or more functions of each of the components in the same or similar manner as they are performed by a corresponding one among the components before the integration. According to an embodiment, operations performed by the module, the program, or another component may be carried out sequentially, in parallel, repeatedly, or heuristically, or one or more of the operations may be executed in a different order or omitted, or one or more other operations may be added.

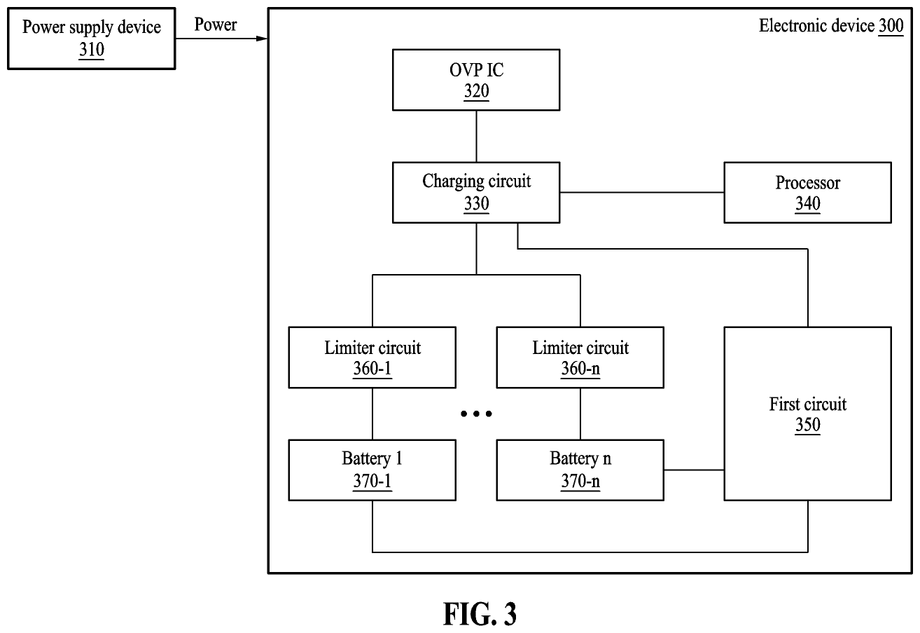

FIG. 3 is a block diagram illustrating an example configuration of an electronic device, according to various embodiments.

Referring to FIG. 3, an electronic device 300 (e.g., the electronic device 101 of FIG. 1) may include an overvoltage protection integrated circuit (OVP IC) 320, a charging circuit 330 (e.g., the charging circuit 210 of FIG. 2), a processor (e.g., including processing circuitry) 340 (e.g., the processor 120 of FIG. 1), a first circuit 350, a plurality of limiter circuits 360-1 to 360-n, and a plurality of batteries 370-1 to 370-n.

According to various embodiments, each of the batteries 370-1 to 370-n may be an example of the battery 189 of FIG. 1.

At least one of the components of the electronic device 300 may be the same as or similar to at least one of the components of the electronic device 100 of FIG. 1, and a repeated description thereof is omitted hereinafter.

According to various embodiments, the electronic device 300 may be connected to a power supply device 310 (e.g., an adapter or a wireless charging pad) by wire or wirelessly (e.g., electromagnetic coupling).

According to various embodiments, when the voltage of power supplied from the power supply device 310 is less than a certain level, the OVP IC 320 may relay the supplied power to the charging circuit 330. When a voltage of power supplied from the power supply device 310 is greater than or equal to a certain level, the OVP IC 320 may turn off a switch in the OVP IC 320 and may prevent and/or reduce the supplied power from outputting from the OVP 320. The OVP IC 320 may protect the components of the electronic device 300 from overvoltage power. Referring to FIG. 3, the OVP IC 320 may be outside the charging circuit 330. Examples are not limited thereto, and the OVP IC 320 may be included in the charging circuit 330.

According to various embodiments, the first circuit 350 may sense respective voltages of the batteries 370-1 to 370-n and may obtain respective voltage values of the batteries 370-1 to 370-n. The first circuit 350 may obtain the respective voltage values of the batteries 370-1 to 370-n when the batteries 370-1 to 370-n are charged, may obtain the respective voltage values of the batteries 370-1 to 370-n when the batteries 370-1 to 370-n are discharged, and may obtain the respective voltage values of the batteries 370-1 to 370-n when some of the batteries 370-1 to 370-n are discharged and the rest of the batteries 370-1 to 370-n are charged.

According to various embodiments, the first circuit 350 may relay a voltage value selected from among the respective voltage values of the batteries 370-1 to 370-n to the charging circuit 330. According to an embodiment, the first circuit 350 may select a minimum voltage value from among the respective voltage values of the batteries 370-1 to 370-n and may relay the selected minimum voltage value to the charging circuit 330. The first circuit 350 may select a maximum voltage value from among the respective voltage values of the batteries 370-1 to 370-n and may relay the selected maximum voltage value to the charging circuit 330. The first circuit 350 may relay a voltage value selected by the processor 340 from among the respective voltage values of the batteries 370-1 to 370-n to the charging circuit 330.

According to various embodiments, each of the limiter circuits 360-1 to 360-n may enable a charging current to flow into each of the batteries 370-1 to 370-n or may enable a discharging current of each of the batteries 370-1 to 370-n to supply to the components of the electronic device 300. In an embodiment, each of the limiter circuits 360-1 to 360-n may include a first transistor and a second transistor. When the batteries 370-1 to 370-n are charged, the first transistor of each of the limiter circuits 360-1 to 360-n may be turned off and the second transistor may be turned on. When the batteries 370-1 to 370-n are discharged, the second transistor of each of the limiter circuits 360-1 to 360-n may be turned off and the first transistor may be turned on.

According to various embodiments, each of the limiter circuits 360-1 to 360-n may include a power gauge (e.g., the power gauge 230 of FIG. 2). The power gauge of each of the limiter circuits 360-1 to 360-n may acquire the state information (e.g., a state of charge (SOC), a current value, a voltage value, and/or a temperature value) of each of the batteries 370-1 to 370-n. The power gauge of each of the limiter circuits 360-1 to 360-n may relay the state information of the batteries 370-1 to 370-n to the processor 340.

According to various embodiments, a voltage value obtained by each power gauge includes a voltage value by direct current resistance (DCR), and thus, the accuracy of the respective voltage values, which are obtained by the first circuit 350, of the batteries 370-1 to 370-n may be higher than that of a voltage value obtained by each power gauge. The electronic device 300 may perform charge control on the batteries 370-1 to 370-n based on a voltage value selected depending on the state of the batteries 370-1 to 370-n.

### Prequalification Charging (Pre-Charging)

According to various embodiments, when the electronic device 300 is connected to the power supply device 310 by wire or wirelessly, the first circuit 350 may obtain the respective voltage values₁ (or initial voltage values) of the batteries 370-1 to 370-n.

According to various embodiments, the first circuit 350 may determine whether the obtained respective voltage values₁ exceed a first threshold voltage value (e.g., 3.1 V). In an embodiment, the first circuit 350 may determine whether the respective voltage values₁ exceed the first threshold voltage value to verify whether each of the batteries 370-1 to 370-n has a voltage sufficient for high-speed constant current (CC) charging to be described later.

According to various embodiments, the first circuit 350 may relay whether the obtained respective voltage values₁ exceed the first threshold voltage value to the charging circuit 330 and/or the processor 340. For example, the first circuit 350 may relay information indicating the obtained respective voltage values₁ exceed the first threshold voltage value to the charging circuit 330 and/or the processor 340. The first circuit 350 may relay information indicating one or more of the obtained respective voltage values₁ are less than or equal to the first threshold voltage value to the charging circuit 330 and/or the processor 340.

According to various embodiments, the first circuit 350 may operate in a first mode when one or more of the obtained respective voltage values₁ are less than or equal to the first threshold voltage value. The first mode may be an operation mode in which the first circuit 350 selects a minimum voltage value from among given voltage values.

According to various embodiments, the charging circuit 330 may perform pre-charging when one or more of the obtained respective voltage values₁ are less than or equal to the first threshold voltage value. The pre-charging may be low-speed charging. According to an embodiment, the charging circuit 330 may charge the batteries 370-1 to 370-n with a constant current of a charging current value₁ (e.g., a 0.1 C-rate). Hereinafter, the C-rate is referred to as “C”.

According to various embodiments, in the first mode, the first circuit 350 may select a minimum voltage value from among respective voltage values of the batteries 370-1 to 370-n that are pre-charged and may determine whether the selected minimum voltage value exceeds the first threshold voltage value. When the minimum voltage value does not exceed the first threshold voltage value, the first circuit 350 may repeat an operation of selecting the minimum voltage value from among the respective voltage values of the batteries 370-1 to 370-n that are pre-charged and an operation of determining whether the minimum voltage value exceeds the first threshold voltage value. When the minimum voltage value of the respective voltage values of the batteries 370-1 to 370-n that are pre-charged exceeds the first threshold voltage value, the first circuit 350 may switch an operation mode from the first mode to a second mode. The second mode may be an operation mode in which the first circuit 350 selects a maximum voltage value from among given voltage values. In the second mode, the first circuit 350 may select a maximum voltage value from among the respective voltage values of the batteries 370-1 to 370-n and may relay the selected maximum voltage value to the charging circuit 330. The charging circuit 330 may determine a charging current value based on the maximum voltage value and may perform CC charging to be described below on the batteries 370-1 to 370-n.

### CC Charging/Constant Voltage (CV)) Charging

According to various embodiments, when the respective voltage values₁ (or the initial voltage values) of the batteries 370-1 to 370-n exceed the first threshold voltage value, the processor 340 may control the first circuit 350 to operate in the second mode.

According to various embodiments, when the respective voltage values₁ of the batteries 370-1 to 370-n exceed the first threshold voltage value, in the second mode, the first circuit 350 may relay a maximum voltage value (hereinafter expressed by a maximum voltage valueᵢₙᵢ) of the respective voltage values₁ of the batteries 370-1 to 370-n to the charging circuit 330.

According to various embodiments, the charging circuit 330 may determine a charging current value₂ based on the maximum voltage valueᵢₙᵢ. For example, a current value by a voltage value may be stored in a memory (not shown) in the charging circuit 330. The charging circuit 330 may determine the charging current value₂ to be 2 C, referring to the current value by a voltage value stored in the memory when the maximum voltage valueᵢₙᵢ is 4.2 V.

According to various embodiments, the charging circuit 330 may charge the batteries 370-1 to 370-n in a CC mode, based on the charging current value₂. Charging in the CC mode may be high-speed charging (or superhigh-speed charging). In an embodiment, the charging circuit 330 may request the power supply device 310 for power for the maximum voltage value and the charging current value₂ and may receive the power of a constant current from the power supply device 310. The charging circuit 330 may charge the batteries 370-1 to 370-n with the power of a constant current.

According to various embodiments, the first circuit 350 may periodically obtain respective voltage values of the batteries 370-1 to 370-n that may be charged in the CC mode and may relay a maximum voltage value of the respective voltage values of the batteries 370-1 to 370-n at each point to the charging circuit 330.

According to various embodiments, the charging circuit 330 may periodically receive a maximum voltage value from the first circuit 350 while charging the batteries 370-1 to 370-n in the CC mode and may verify whether the maximum voltage value received at each point reaches (or is greater than or equal to) a second threshold voltage value (e.g., 4.4 V). When a maximum voltage value received at a timepoint₁ reaches (or greater than or equal to) the second threshold voltage value, the charging circuit 330 may charge the batteries 370-1 to 370-n in a CV mode. For example, the charging circuit 330 may charge the batteries 370-1 to 370-n with the power of a constant voltage of 4.4 V.

According to various embodiments, the charging circuit 330 may notify the processor 340 of switching from the CC mode to the CV mode.

According to various embodiments, the processor 340 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions. The processor 340 may for example, receive state information from a power gauge of each of the batteries 370-1 to 370-n while the batteries 370-1 to 370-n are being charged in the CV mode. The power gauge of each of the batteries 370-1 to 370-n may indicate a power gauge included in each of the limiter circuits 360-1 to 360-n.

According to various embodiments, the processor 340 may determine whether a current value received from each power gauge is less than a termination current value (e.g., less than 0.1 C). The processor 340 may determine a battery in which a current value is less than the termination current value is fully charged and may determine a battery in which a current value is greater than or equal to the termination current value is not fully charged.

According to various embodiments, the processor 340 may set the fully charged battery to a supplement mode. A battery set to the supplement mode may be discharged without being charged.

### Charging of Not Fully Charged Battery

According to various embodiments, when some of the batteries 370-1 to 370-n are not fully charged, the processor 340 may select one of the batteries that are not fully charged using the state information of the batteries that are not fully charged. For example, the processor 340 may select a battery in the highest charged state from among the batteries that are not fully charged.

According to various embodiments, when selecting one of the batteries that are not fully charged, the processor 340 may control the first circuit 350 to operate in a third mode. The third mode may be an operation mode in which the first circuit 350 selects a voltage value of a battery selected by the processor 340 from among given voltage values.

According to various embodiments, the charging circuit 330 may charge the batteries that are not fully charged in the CV mode. The first circuit 350 may obtain the respective voltage values of the batteries 370-1 to 370-n. The first circuit 350 may obtain the respective voltage values of batteries in the supplement mode and may obtain the respective voltage values of batteries that are being charged in the CV mode. The first circuit 350 may relay a voltage value of a battery selected by the processor 340 from among the obtained respective voltage values to the charging circuit 330. In an embodiment, the charging circuit 330 may monitor the battery selected by the processor 340 to prevent and/or reduce an overvoltage state.

According to various embodiments, the processor 340 may receive the state information of each of the batteries 370-1 to 370-n from a power gauge of each of the batteries 370-1 to 370-n. In an embodiment, the processor 340 may determine whether the respective current values of some batteries that are being charged in the CV mode are less than the termination current value. When the respective current values of the batteries that are being charged in the CV mode are less than the termination current value, the processor 340 may determine each of the batteries that are being charged in the CV mode is fully charged, and the batteries determined to be fully charged may be set to the supplement mode.

According to various embodiments, the processor 340 may determine that the charging of the batteries 370-1 to 370-n is terminated when each of the batteries 370-1 to 370-n is determined to be fully charged.

### Recharging

According to various embodiments, after the charging of the batteries 370-1 to 370-n is terminated, the electronic device 300 may be connected to the power supply device 310 by wire or wirelessly. For example, the electronic device 300 may be connected to the adapter or may be on the wireless charging pad even after the charging of the batteries 370-1 to 370-n is terminated. While the electronic device 300 is connected to the power supply device 310, the batteries 370-1 to 370-n may be discharged in the supplement mode, voltages of one or more of or all the batteries 370-1 to 370-n may decrease, and there may be a battery that requires recharging among the batteries 370-1 to 370-n.

According to various embodiments, the processor 340 may identify whether there is a battery that requires recharging among the batteries 370-1 to 370-n after the charging of the batteries 370-1 to 370-n is terminated. In an embodiment, the processor 340 may receive the state information of each of the batteries 370-1 to 370-n from the power gauge of each of the batteries 370-1 to 370-n and may identify whether there is a battery that requires recharging among the batteries 370-1 to 370-n using the received state information. For example, the processor 340 may compare a voltage value received from the power gauge of each of the batteries 370-1 to 370-n with a third threshold voltage value and may determine that a battery of which the voltage value is less than (or equal to) the third threshold voltage value requires to be recharged. In an embodiment, the third threshold voltage value may be a value obtained by subtracting a certain value (e.g., a value between 70 mV and 100 mV) from the second threshold voltage value (e.g., 4.4 V).

According to various embodiments, when some of the batteries 370-1 to 370-n require to be recharged, the processor 340 may select one of the batteries that require recharging using the state information of each of the batteries that require recharging. For example, the processor 340 may select a battery in the highest charged state from among the batteries that require recharging. When selecting one of the batteries that require recharging, the processor 340 may control the first circuit 350 to operate in the third mode. In the third mode, the first circuit 350 may obtain the respective voltage values of the batteries 370-1 to 370-n and may relay a voltage value of the selected battery among the batteries that require recharging to the charging circuit 330. The charging circuit 330 may charge the batteries that require recharging in the CV mode.

According to various embodiments, there may be one battery that requires recharging among the batteries 370-1 to 370-n. When there is one battery that requires recharging, the processor 340 may control the first circuit 350 to operate in the third mode. In the third mode, the first circuit 350 may obtain the respective voltage values of the batteries 370-1 to 370-n and may relay a voltage value of the battery that requires recharging among the respective voltage values of the batteries 370-1 to 370-n to the charging circuit 330. The charging circuit 330 may charge the battery that requires recharging in the CV mode.

According to various embodiments, the processor 340 may determine that all the batteries 370-1 to 370-n require to be recharged. When determining all the batteries 370-1 to 370-n require to be recharged, the processor 340 may control the first circuit 350 to operate in the second mode and may command (or request) the charging circuit 300 to charge (e.g., CV charge) the batteries 370-1 to 370-n. In the second mode, the first circuit 350 may obtain the respective voltage values of the batteries 370-1 to 370-n and may relay a maximum voltage value among the respective voltage values of the batteries 370-1 to 370-n to the charging circuit 330. The charging circuit 330 may charge the batteries 370-1 to 370-n in the CV mode.

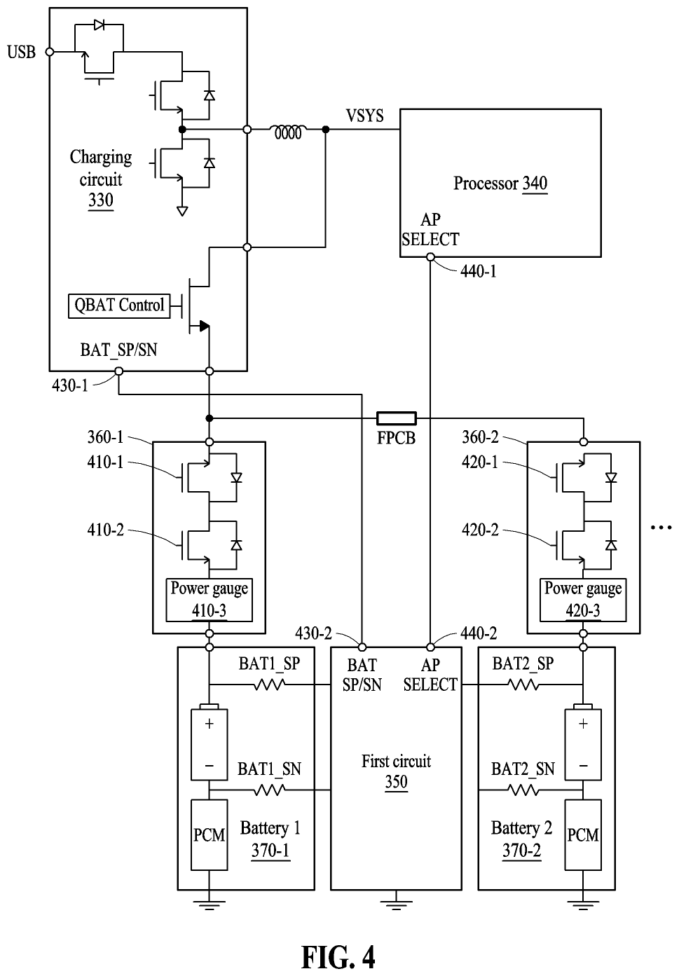

FIG. 4 is a diagram illustrating an example of circuit configuration of the electronic device 300, according to various embodiments.

FIG. 4 illustrates an example of the charging circuit 330, the processor (e.g., including processing circuitry) 340, the limiter circuits 360-1 and 360-2, the batteries 370-1 and 370-2, and the first circuit 350. For ease of description, respective examples of the limiter circuits 360-1 and 360-2 and the batteries 1 and 2 370-1 and 370-2 are illustrated in FIG. 4.

According to various embodiments, the first circuit 350 may include a plurality of voltage sensors (not shown). Each voltage sensor in the first circuit 350 may sense the respective voltages of the batteries 370-1 to 370-n and may obtain respective voltage values of the batteries 370-1 to 370-n.

According to various embodiments, each voltage sensor in the first circuit 350 may sense a voltage of both ends of each of the batteries 370-1 to 370-n and may obtain the respective voltage values of the batteries 370-1 to 370-n. The voltage values obtained by each voltage sensor may not include a false voltage value due to DCR in a charging path. The first circuit 350 may obtain an accurate voltage value of each of the batteries 370-1 to 370-n.

According to various embodiments, the charging circuit 330 may include a port BAT SP/SN 430-1, and the first circuit 350 may include a port BAT SP/SN 430-2. The port 430-1 of the charging circuit 300 may be connected to the port 430-2 of the first circuit 350 via a line. The first circuit 350 may select one of the respective voltage values of the batteries 370-1 to 370-n in each of the first to third modes and may relay the selected voltage value to the charging circuit 330 via the port 430-2. The charging circuit 330 may receive the voltage value selected by the first circuit 350 from the first circuit 350 via the port 430-1.

According to various embodiments, the processor 340 may include a port AP SELECT 440-1 and the first circuit 350 may include a port AP SELECT 440-2. The port 440-1 of the processor 340 may be connected to the port 440-2 of the first circuit 350 via a line. The processor 340 may select one (e.g., a battery that is not fully charged or a battery that requires recharging) of the batteries 370-1 to 370-n and may relay information on the selected battery to the first circuit 350 via the port 440-1. The first circuit 350 may receive the information on the battery selected by the processor 340 from the processor 340 via the port 440-2. The first circuit 350 may select a voltage value of the battery selected by the processor 340 from among the batteries 370-1 to 370-n and relay the selected voltage value to the charging circuit 330.

According to various embodiments, the limiter circuit 360-1 may include a first transistor 410-1, a second transistor 410-2, and a power gauge 410-3. When charging the battery 1 370-1, the processor 340 may turn off the first transistor 410-1 and may turn on the second transistor 410-2. The charging circuit 330 may supply power to the battery 1 370-1 and may charge the battery 1 370-1. When the battery 1 370-1 is fully charged, the processor 340 may set the battery 1 370-1 to a supplement mode, may turn on the first transistor 410-1, and may turn off the second transistor 410-2. The battery 1 370-1 may be discharged in the supplement mode. The power gauge 410-3 may acquire the state information of the battery 1 370-1 and may relay the state information to the processor 340. In the example illustrated in FIG. 4, the power gauge 410-3 may be inside the limiter circuit 360-1. Examples are not limited thereto, and the power gauge 410-3 may be outside the limiter circuit 360-1 and may acquire the state information of the battery 1 370-1.

The limiter circuit 360-2 may include a first transistor 420-1, a second transistor 420-2, and a power gauge 420-3. The description of the limiter circuit 360-1 may apply to the description of the limiter circuit 360-2 and a limiter circuit of each of the remaining batteries.

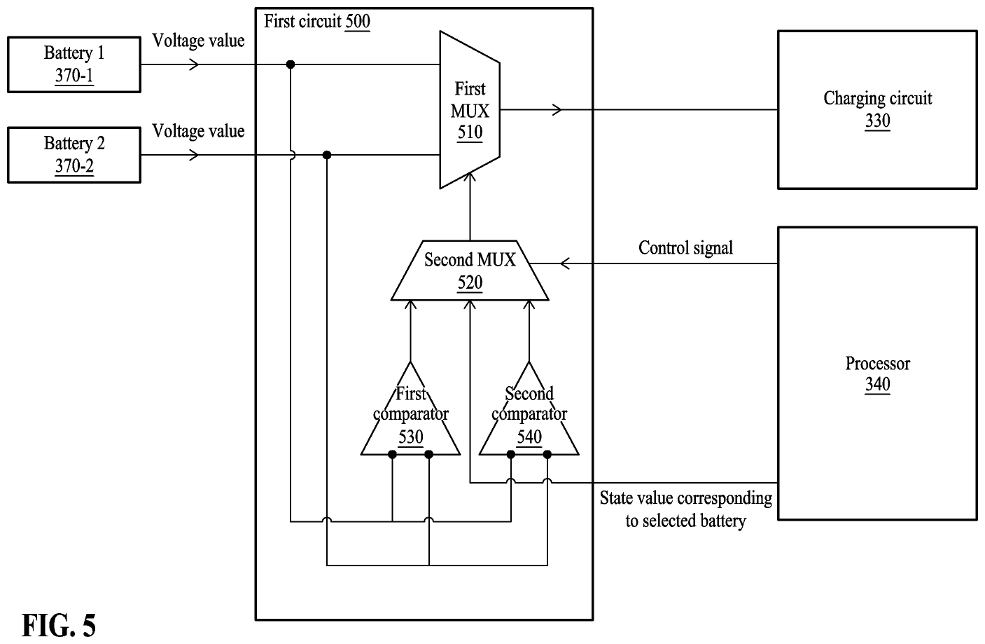

FIG. 5 is a diagram illustrating an example first circuit in the electronic device 300, according to various embodiments.

FIG. 5 illustrates an example of a first circuit 500 including the two batteries 370-1 and 370-2. The first circuit 500 may be an example of the first circuit 350 of FIGS. 3 and 4. The description provided with reference to FIG. 5 is also applicable when the electronic device 300 includes three or more batteries.

According to various embodiments, the first circuit 500 may include a first MUX 510, a second MUX 520, a first comparator 530, and a second comparator 540. Although not illustrated in FIG. 5, the first circuit 500 may include a voltage sensor of each of the batteries 370-1 and 370-2.

According to various embodiments, the first circuit 500 may operate in a first mode. The first mode may be an operation mode in which the first circuit 500 selects a minimum voltage value among given voltage values. In an embodiment, the first circuit 500 may include a control circuit (not shown), and the control circuit may cause the first circuit 500 to operate in the first mode when one or more of the respective voltage values₁ of the batteries 370-1 and 370-2 are less than or equal to a first threshold voltage value. For example, when one or more of the respective voltage values₁ of the batteries 370-1 and 370-2 are less than or equal to the first threshold voltage value, the control circuit may relay a first control signal indicating to operate in the first mode to the second MUX 520. The second MUX 520 may operate such that an output of the first comparator 530 is input as a control signal of the first MUX 510, based on the first control signal. In an embodiment, the operation of the control circuit in the first circuit 500 described above may be implemented by the processor 340.

According to various embodiments, in the first mode, each voltage sensor may obtain the respective voltage valuesₐ of the batteries 370-1 and 370-2, and the first MUX 510 may receive the respective voltage valuesₐ of the batteries 370-1 and 370-2 as an input from each voltage sensor. In the first mode, the first comparator 530 may compare the respective voltage valuesₐ of the batteries 370-1 and 370-2 with one another and may output a state value corresponding to a battery having a minimum voltage value among the respective voltage valuesₐ of the batteries 370-1 and 370-2 to the second MUX 520. In the first mode, the second MUX 520 may operate such that the state value output from the first comparator 530 is input as a control signal of the first MUX 510. The first MUX 510 may relay a voltage value of the battery corresponding to the state value output from the first comparator 530 among the respective voltage values of the batteries 370-1 and 370-2 to the charging circuit 330. For example, the first comparator 530 may output a state value₁ corresponding to the battery 1 370-1 to the second MUX 520 when a voltage valueₐ of the battery 1 370-1 is the smallest among the respective voltage valuesₐ of the batteries 370-1 and 370-2. The second MUX 520 may relay the state value₁ to the first MUX 510, and the first MUX 510 may relay the voltage valueₐ of the battery 1 370-1 corresponding to the state value₁ among the respective voltage valuesₐ of the batteries 370-1 and 370-2 to the charging circuit 330. The first MUX 510 may select a voltage valueₐ of the battery 370-1 from among the respective voltage values of the batteries 370-1 and 370-2, based on the state value₁, and may relay the selected voltage valueₐ to the charging circuit 330.

According to various embodiments, the first circuit 500 may operate in a second mode. The second mode may be an operation mode in which the first circuit 500 selects a maximum voltage value from among given voltage values. In an embodiment, when the respective voltage values₁ of the batteries 370-1 and 370-2 exceed the first threshold voltage value, the processor 340 may relay a second control signal indicating to operate the first circuit 500 in the second mode to the second MUX 520. The second MUX 520 may operate such that an output of the second comparator 540 is input as a control signal of the first MUX 510, based on the second control signal.

According to various embodiments, in the second mode, each voltage sensor may obtain the respective voltage values_{b} of the batteries 370-1 and 370-2, and the first MUX 510 may receive the respective voltage values_{b} of the batteries 370-1 and 370-2 as an input from each voltage sensor. In the second mode, the second comparator 540 may compare the respective voltage values_{b} of the batteries 370-1 and 370-2 with one another and may output a state value corresponding to a battery having a maximum voltage value among the respective voltage values_{b} of the batteries 370-1 and 370-2 to the second MUX 520. In the second mode, the second MUX 520 may operate such that the state value output from the second comparator 540 is input as a control signal of the first MUX 510. The first MUX 510 may relay a voltage value of the battery corresponding to the state value output from the second comparator 540 among the respective voltage values of the batteries 370-1 and 370-2 to the charging circuit 330. For example, the second comparator 540 may output a state value₂ corresponding to the battery 2 370-2 to the second MUX 520 when a voltage value_{b} of the battery 2 370-2 is the largest among the respective voltage values_{b} of the batteries 370-1 and 370-2. The second MUX 520 may relay the state value₂ to the first MUX 510, and the first MUX 510 may relay the voltage value_{b} of the battery 2 370-2 corresponding to the state value₂ among the respective voltage values_{b} of the batteries 370-1 and 370-2 to the charging circuit 330. The first MUX 510 may select a voltage value_{b} of the battery 2 370-2 from among the respective voltage values of the batteries 370-1 and 370-2, based on the state value₂, and may relay the selected voltage value_{b} to the charging circuit 330.

According to various embodiments, the first circuit 500 may operate in a third mode. The third mode may be an operation mode in which the first circuit 500 selects a voltage value of a battery selected by the processor 340 from among given voltage values. In an embodiment, the processor 340 may select a battery that is not fully charged when some of the batteries 370-1 and 370-2 are not fully charged or may select a battery that requires recharging from among the batteries 370-1 and 370-2 after the charging of the batteries 370-1 and 370-2 is terminated. When selecting a battery that is not fully charged (or a battery that requires recharging), the processor 340 may relay a third control signal indicating the first circuit 500 to operate in the third mode and a state value corresponding to the selected battery to the second MUX 520. Based on the third control signal, the second MUX 520 may operate such that the state value, which is selected by the processor 340, corresponding to the battery is input as a control signal to the first MUX 510.

According to various embodiments, in the third mode, each voltage sensor may obtain the respective voltage values_{c} of the batteries 370-1 and 370-2, and the first MUX 510 may receive the respective voltage values_{c} of the batteries 370-1 and 370-2 as an input from each voltage sensor. In the third mode, the second MUX 520 may relay the state value, which is selected by the processor 340, corresponding to the battery to the first MUX 510. The first MUX 510 may relay a voltage value_{c} selected by the processor 340 from among the respective voltage values_{c} of the batteries 370-1 to 370-n to the charging circuit 330. For example, the processor 340 may select the battery 1 370-1 when the battery 1 370-1 is not fully charged and may relay a state value₁ corresponding to the third control signal and the battery 1 370-1 to the second MUX 520. The second MUX 520 may output the state value₁ received from the processor 340 to the first MUX 510. The first MUX 510 may relay a voltage value of the battery 1 370-1 corresponding to the state value₁ among the respective voltage values of the batteries 370-1 and 370-2 to the charging circuit 330. The first MUX 510 may select the voltage value_{c} of the battery 370-1 from among the respective voltage values of the batteries 370-1 and 370-2, based on the state value₁, and may relay the selected voltage value_{c} to the charging circuit 330.

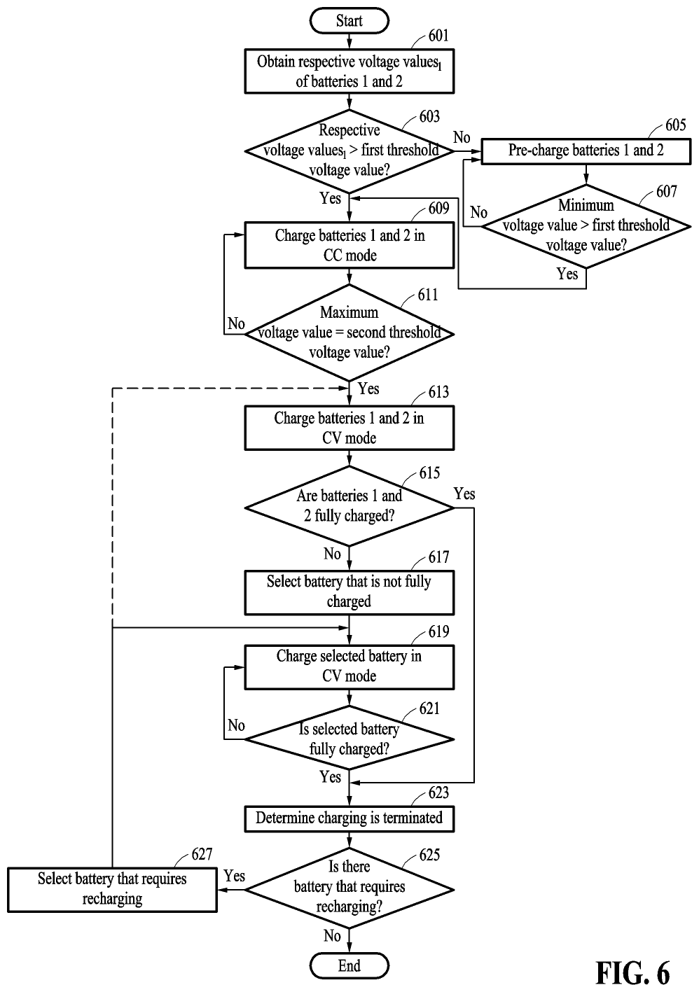

FIG. 6 is a flowchart illustrating an example charging operation of an electronic device, according to various embodiments.

FIG. 6 is a flowchart illustrating an example of a charging operation when the electronic device 300 includes the batteries 1 and 2 370-1 and 370-2. The charging operation to be described with reference to FIG. 6 is also applicable to the charging operation of the electronic device 300 including three or more batteries.

In operation 601, the electronic device 300 may obtain respective voltage values₁ of the battery 1 370-1 and the battery 2 370-2. In an embodiment, when the electronic device 300 is connected to the power supply device 310 by wire or wirelessly, the first circuit 500 may sense the respective voltages of the battery 1 370-1 and the battery 2 370-2 and may obtain the respective voltage values₁ of the battery 1 370-1 and the battery 2 370-2.

In operation 603, the electronic device 300 may determine whether the respective voltage values₁ of the battery 1 370-1 and the battery 2 370-2 exceed a first threshold voltage value. In an embodiment, the electronic device 300 may determine whether the respective voltage values₁ of the battery 1 370-1 and the battery 2 370-2 exceed the first threshold voltage value to verify whether the respective voltages of the battery 1 370-1 and the battery 2 370-2 are sufficient to be charged in a CC mode. For example, the first circuit 500 (or the processor 340) may determine whether the respective voltage values₁ of the battery 1 370-1 and the battery 2 370-2 exceed the first threshold voltage value.

The electronic device 300 may pre-charge the battery 1 370-1 and the battery 2 370-2 in operation 605 when one or more of the respective voltage values₁ of the battery 1 370-1 and the battery 2 370-2 are less than or equal to the first threshold voltage value (No in operation 603). In an embodiment, the first circuit 500 may operate in the first mode when one or more of the respective voltage values₁ of the battery 1 370-1 and the battery 2 370-2 are less than or equal to the first threshold voltage value, and the charging circuit 330 may charge the battery 1 370-1 and the battery 2 370-2 based on a charging current value₁ (e.g., 0.1 C). In the first mode, the first circuit 500 may periodically obtain respective voltage values of the battery 1 370-1 and the battery 2 370-2 that are pre-charged and may relay a minimum voltage value among the respective voltage values of the battery 1 370-1 and the battery 2 370-2 to the charging circuit 330 at each point. The charging circuit 330 may periodically receive a minimum voltage value from the first circuit 500.

In operation 607, the electronic device 300 may determine whether the minimum voltage value among the respective voltage values of the battery 1 370-1 and the battery 2 370-2 that are pre-charged exceed the first threshold voltage value. In an embodiment, the first circuit 500 may perform operation 607.

The electronic device 300 may pre-charge the battery 1 370-1 and the battery 2 370-2 in operation 605 when the minimum voltage value among the respective voltage values of the battery 1 370-1 and the battery 2 370-2 are less than or equal to the first threshold voltage value (No in operation 607). When the respective voltage values₁ of the battery 1 370-1 and the battery 2 370-2 exceed the first threshold voltage value (Yes in operation 603), or the minimum voltage value among the respective voltage values of the battery 1 370-1 and the battery 2 370-2 exceeds the first threshold voltage value (Yes in operation 607), the electronic device 300 may charge the battery 1 370-1 and the battery 2 370-2 in the CC mode in operation 609.

In an embodiment, when the respective voltage values₁ of the battery 1 370-1 and the battery 2 370-2 exceed the first threshold voltage value (Yes in operation 603), the processor 340 may control the first circuit 500 to operate in a second mode. In the second mode, the first circuit 500 may relay a maximum voltage value among the respective voltage values₁ of the battery 1 370-1 and the battery 2 370-2 to the charging circuit 330. The charging circuit 330 may determine a charging current value₂ based on the received maximum voltage value. The charging circuit 330 may request the power supply device 310 for power for the maximum voltage value and the charging current value₂ and may receive the power of a constant current from the power supply device 310. The charging circuit 330 may charge the battery 1 370-1 and the battery 2 370-2 with the power of a constant current.

In an embodiment, when the minimum voltage value among the respective voltage values of the battery 1 370-1 and the battery 2 370-2 that are pre-charged exceeds the first threshold voltage value (Yes in operation 607), the first circuit 500 may switch an operation mode from the first mode to the second mode. In the second mode, the first circuit 500 may relay a maximum voltage value among the respective voltage values of the battery 1 370-1 and the battery 2 370-2 to the charging circuit 330. The charging circuit 330 may determine a charging current valueₐ based on the received maximum voltage value and may request the power supply device 310 for power for the maximum voltage value and the charging current valueₐ. The charging circuit 330 may receive the power of a constant current from the power supply device 310 and may charge the battery 1 370-1 and the battery 2 370-2 with the power of a constant current.

In operation 611, the electronic device 300 may determine whether the maximum voltage value among the respective voltage values of the battery 1 370-1 and the battery 2 370-2 that are charged in the CC mode reaches a second threshold voltage value. When the maximum voltage value is less than the second threshold voltage value (No in operation 611), the electronic device 300 may charge the battery 1 370-1 and the battery 2 370-2 in the CC mode in operation 609. When the maximum voltage value reaches the second threshold voltage value (Yes in operation 611), the electronic device 300 may charge the battery 1 370-1 and the battery 2 370-2 in a CV mode in operation 613.

In an embodiment, the first circuit 500 may periodically obtain respective voltage values of the battery 1 370-1 and the battery 2 370-2 that are charged in the CC mode. The first circuit 500 may relay a maximum voltage value at each point among the respective voltage values of the battery 1 370-1 and the battery 2 370-2 to the charging circuit 330. The charging circuit 330 may periodically receive the maximum voltage value from the first circuit 500 and may determine whether the maximum voltage value received at each point reaches the second threshold voltage value. When the maximum voltage value received from the first circuit 500 at a timepoint₁ is less than the second threshold voltage value (No in operation 611), the charging circuit 330 may charge the battery 1 370-1 and the battery 2 370-2 in the CC mode in operation 609. When the maximum voltage value received from the first circuit 500 at the timepoint₁ reaches the second threshold voltage value (Yes in operation 611), the charging circuit 330 may charge the battery 1 370-1 and the battery 2 370-2 in the CV mode in operation 613.

In operation 615, the electronic device 300 may determine whether each of the battery 1 370-1 and the battery 2 370-2 is fully charged. In an embodiment, the processor 340 may receive a current value of the battery 1 370-1 from the power gauge 410-3 of the battery 1 370-1 and may receive a current value of the battery 2 370-2 from the power gauge 420-3 of the battery 370-2. When the respective current values of the battery 1 370-1 and the battery 2 370-2 are less than a termination current value, the processor 340 may determine that each of the battery 1 370-1 and the battery 2 370-2 is fully charged (Yes in operation 615). When a current value is greater than or equal to the termination current value, the processor 340 may determine that a battery having the current value is not fully charged (No in operation 615). The processor 340 may set a fully charged battery to be in a supplement mode. For example, the processor 340 may determine that the battery 1 370-1 having a current value that is less than the termination current value is fully charged. The processor 340 may set the battery 1 370-1 to be in the supplement mode. The processor 340 may determine that the battery 2 370-2 having a current value that is greater than or equal to the termination current value is not fully charged.

In operation 617, the electronic device 300 may select a battery that is not fully charged. In operation 619, the electronic device 300 may charge the selected battery in the CV mode. In an embodiment, the processor 340 may select the battery that is not fully charged (e.g., the battery 2 370-2) as a battery that requires additional charging. When selecting the battery that requires additional charging, the processor 340 may control the first circuit 500 to operate in a third mode. In the third mode, the first circuit 500 may obtain the respective voltage values of the battery 1 370-1 and the battery 2 370-2 and may relay a voltage value selected by the processor 340 among the respective voltage values of the battery 1 370-1 and the battery 2 370-2 to the charging circuit 330. The charging circuit 330 may charge the selected battery in the CV mode.

In operation 621, the electronic device 300 may determine whether the selected battery is fully charged. When the selected battery is not fully charged (No in operation 621), the electronic device 300 may charge the selected battery in the CV mode in operation 619. When the selected battery is fully charged (Yes in operation 621), the electronic device 300 may determine that charging is terminated in operation 623.

In an embodiment, in operation 621, the processor 340 may receive a current value from a power gauge of the selected battery. The processor 340 may determine the selected battery is not fully charged (No in operation 621) when the current value of the selected battery is greater than or equal to the termination current value, and the charging circuit 330 may charge the selected battery in the CV mode in operation 619. The processor 340 may determine the selected battery is fully charged (Yes in operation 621) when the current value of the selected battery is less than the termination current value. The processor 340 may set the selected battery to be in the supplement mode. The processor 340 may determine that the charging is terminated in operation 623 with the determination that each of the battery 1 370-1 and the battery 2 370-2 is fully charged.

In operation 625, the electronic device 300 may determine whether there is a battery that requires recharging among the battery 1 370-1 and the battery 2 370-2. In an embodiment, the processor 340 may receive a voltage value of the battery 1 370-1 from the power gauge 410-3 of the battery 1 370-1 and may receive a voltage value of the battery 2 370-2 from the power gauge 420-3 of battery 370-2. The processor 340 may determine whether the respective voltage values of the battery 1 370-1 and the battery 2 370-2 are less than or equal to a third threshold voltage value. For example, when the voltage value of the battery 1 370-1 exceeds the third threshold voltage value, the processor 340 may determine the battery 1 370-1 does not require recharging, and, when the voltage value of the battery 2 370-2 is less than or equal to the third threshold voltage value, may determine the battery 2 370-2 requires recharging.

When there is a battery that requires recharging (Yes in operation 625), the electronic device 300 may select the battery that requires recharging in operation 627. When selecting the battery that requires recharging, the electronic device 300 may perform operations 619 to 623. In an embodiment, when selecting the battery that requires recharging, the processor 340 may control the first circuit 500 to operate in the third mode. The charging circuit 330 may charge the battery that requires recharging in the CV mode. In the third mode, the first circuit 500 may obtain the respective voltage values of the battery 1 370-1 and the battery 2 370-2 and may relay a voltage value of the battery that requires recharging among the battery 1 370-1 and the battery 2 370-2 to the charging circuit 330. The charging circuit 330 may monitor the voltage value of the battery that requires recharging.

In an embodiment, the electronic device 300 may determine both the battery 1 370-1 and the battery 2 370-2 require recharging in operation 625. When determining both the battery 1 370-1 and the battery 2 370-2 require recharging, the electronic device 300 may perform operations 613, 615, and 623 or operations 613, 615, 617, 619, 621, and 623. For example, when both the battery 1 370-1 and the battery 2 370-2 are determined to be requiring recharging in operation 625, the processor 340 may control the first circuit 500 to operate in the second mode. In operation 613, the charging circuit 330 may charge the battery 1 370-1 and the battery 2 370-2 in the CV mode. In the second mode, the first circuit 500 may obtain respective voltage values of the battery 1 370-1 and the battery 2 370-2 that are charged in the CV mode and may relay a maximum voltage value among the respective voltage values of the battery 1 370-1 and the battery 2 370-2 to the charging circuit 330. The charging circuit 330 may monitor a maximum voltage value. In operation 615, the processor 340 may determine whether the battery 1 370-1 and the battery 2 370-2 are fully charged, and, when the battery 1 370-1 and the battery 2 370-2 are fully charged (Yes in operation 615), the processor 340 may determine that the charging of the battery 1 370-1 and the battery 2 370-2 is terminated in operation 623.

The description of the example embodiments described with reference to FIGS. 1 to 5 may apply to the example embodiments described with reference to FIG. 6.

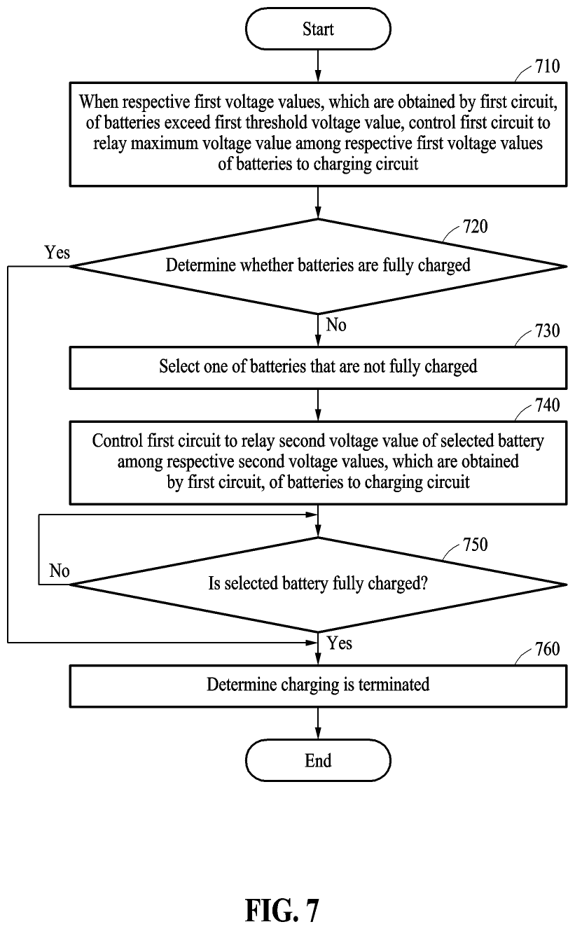

FIG. 7 is a flowchart illustrating an example operating method of an electronic device 300, according to various embodiments.

The operating method to be described with reference to FIG. 7 may be performed by the processor 340.

In operation 710, when the respective first voltage values, which are obtained by the first circuit 350 or 500, of the batteries 370-1 to 370-n exceed a first threshold voltage value, the processor 340 may control the first circuit 350 or 500 to relay a maximum voltage value among the respective first voltage values of the batteries 370-1 to 370-n to the charging circuit 330.

The charging circuit 330 may determine a first charging current value (e.g., the charging current value₂ described with reference to FIG. 3) based on the maximum voltage value and may charge the batteries 370-1 to 370-n in a CC mode, based on the first charging current value. When a maximum voltage value among respective voltage values of the batteries 370-1 to 370-n that are charged in the CC mode is greater than or equal to a second threshold voltage value, the charging circuit 330 may charge the batteries 370-1 to 370-n in a CV mode.

In operation 720, the processor 340 may determine whether the batteries 370-1 to 370-n are fully charged. In an embodiment, the processor 340 may determine whether the respective current values of the batteries 370-1 to 370-n that are charged in the CV mode are less than a termination current value. The processor 340 may determine a battery in which a current value is less than the termination current value is fully charged and may determine a battery in which a current value is greater than or equal to the termination current value is not fully charged.

When the batteries 370-1 to 370-n are fully charged (Yes in operation 720), the processor 340 may determine the charging of the batteries 370-1 to 370-n is terminated in operation 760.

When the batteries 370-1 to 370-n are not fully charged (No in operation 720), the processor 340 may select one of the batteries that are not fully charged in operation 730. The charging circuit 330 may charge the batteries that are not fully charged in the CV mode.

In operation 740, the processor 340 may control the first circuit 350 or 500 to relay a second voltage value of the battery that is selected in operation 730 among respective second voltage values, which are obtained by the first circuit 350 or 500, of the batteries 370-1 to 370-n to the charging circuit 330.

In operation 750, the processor 340 may determine whether some batteries that are charged in the CV mode are fully charged.

When the batteries charged in the CV mode are fully charged (Yes in operation 750), the processor 340 may determine the charging of the batteries 370-1 to 370-n is terminated in operation 760. In an embodiment, when the batteries that are charged in the CV mode are not fully charged (No in operation 750), the processor 340 may repeat operation 750.

According to various embodiments, the first circuit 350 or 500 may obtain respective third voltage values of the batteries 370-1 to 370-n after the charging of the batteries 370-1 to 370-n is terminated. The processor 340 may identify (e.g., operation 625 of FIG. 6) whether there is a battery that requires recharging among the batteries 370-1 to 370-n after the charging of the batteries 370-1 to 370-n is terminated. When there is a battery that requires recharging among the batteries 370-1 to 370-n, the processor 340 may select (e.g., operation 627 of FIG. 6) the battery that requires recharging. The processor 340 may control the first circuit 350 or 500 to relay a third voltage value of a selected battery among the respective third voltage values of the batteries 370-1 to 370-n to the charging circuit 330.

The description of the example embodiments described with reference to FIGS. 1 to 6 may apply to the example embodiments described with reference to FIG. 7.

According to various example embodiments, the electronic device may include: a plurality of batteries, a charging circuit configured to charge the batteries, a first circuit configured to sense a voltage of each of the batteries; obtain respective voltage values of the batteries; and relay one of the obtained voltage values to the charging circuit, and at least one processor, comprising processing circuitry, individually and/or collectively, configured to control the first circuit.

According to various example embodiments, at least one processor, individually and/or collectively, is configured to: based on respective first voltage values (e.g., the respective voltage values₁ described with reference to FIG. 3), obtained by the first circuit, of the batteries exceeding a first threshold voltage value, control the first circuit such that the first circuit relays a maximum voltage value among the respective first voltage values of the batteries to the charging circuit, determine whether the batteries are fully charged, based on some of the batteries not being fully charged, select one of the batteries that are not fully charged, and control the first circuit such that the first circuit relays a second voltage value of the selected battery among respective second voltage values, obtained by the first circuit, of the batteries to the charging circuit.

According to various example embodiments, the charging circuit may be configured to: determine a first charging current value (e.g., the charging current value₂ described with reference to FIG. 3) based on the maximum voltage value and charge the batteries in a first charging mode, based on the determined first charging current value.

According to various example embodiments, the charging circuit may be configured to: periodically receive a maximum voltage value among respective voltage values of the batteries charged in the first charging mode from the first circuit, and, based on the maximum voltage value received at a first timepoint being greater than or equal to a second threshold voltage value, may charge the batteries in a second charging mode.

According to various example embodiments, the first charging mode may include a constant current charging mode and the second charging mode may include a constant voltage charging mode.

According to various example embodiments, at least one processor, individually and/or collectively, may be configured to: acquire state information of the batteries that are not fully charged and select one of the batteries that are not fully charged using the acquired state information.

According to various example embodiments, the first circuit may include a first multiplexer configured to: receive respective third voltage values of the batteries as an input in a first mode, receive respective first voltage values as an input in a second mode, and receive respective second voltage values as an input in a third mode, a first comparator configured to: compare the respective third voltage values with one another in the first mode and output a first state value corresponding to a first battery having a minimum voltage value among the respective third voltage values, the second comparator configured to: compare the respective first voltage values with one another in the second mode and output a second state value corresponding to a second battery having the maximum voltage value among the respective first voltage values, and a second multiplexer configured to: receive the first state value from the first comparator in the first mode, receive the second state value from the second comparator in the second mode, receive a third state value corresponding to the selected battery from at least one processor in the third mode, and output the first to third state values respectively in the first to third modes to the first multiplexer.

According to various example embodiments, the first multiplexer may be configured to: relay the third voltage value of the first battery to the charging circuit, based on the first state value, in the first mode, may relay the first voltage value of the second battery to the charging circuit, based on the second state value, in the second mode, and may relay the second voltage value of the selected battery to the charging circuit in the third mode.

According to various example embodiments, the first circuit may be configured to: determine whether the respective first voltage values of the batteries exceed the first threshold voltage value, and, based on one or more of the respective first voltage values of the batteries being less than or equal to the first threshold voltage value, may relay a first control signal to the second multiplexer to operate in the first mode.

According to various example embodiments, at least one processor, individually and/or collectively, configured to: based on the respective first voltage values of the batteries exceeding the first threshold voltage value, relay a second control signal to the second multiplexer such that the first circuit operates in the second mode, and, based on one of the batteries that are not fully charged being selected, relay a third control signal to the second multiplexer such that the first circuit operates in the third mode.

According to various example embodiments, the first circuit may be configured to obtain respective fourth voltage values of the batteries after charging of the batteries is terminated.

According to various example embodiments, at least one processor, individually and/or collectively, may be configured to: select a battery that requires recharging among the batteries after the charging is terminated and control the first circuit to relay a fourth voltage value of the battery that requires recharging among the respective fourth voltage values of the batteries to the first circuit\.

According to various example embodiments, based on one or more of the respective first voltage values of the batteries being less than or equal to the first threshold voltage value, the charging circuit may be configured to charge the batteries based on a second charging current value (e.g., the charging current value₁ described with reference to FIG. 3).

According to various example embodiments, the first circuit may be configured to: select a minimum voltage value from among respective voltage values of the batteries charged based on the second charging current value, determine whether the selected minimum voltage value exceeds the first threshold voltage value, and, based on the selected minimum voltage value exceeding the first threshold voltage value, switch an operation mode from an operation mode (e.g., the first mode) for selecting the minimum voltage value to an operation mode (e.g., the second mode) for selecting a maximum voltage value of the respective voltage values of the batteries.

According to various example embodiments, the electronic device may include: a plurality of batteries, a charging circuit configured to charge the batteries, a first circuit configured to: relay a minimum voltage value among respective first voltage values obtained by sensing respective voltages of the batteries in a first mode to the charging circuit, relay a maximum voltage value among respective second voltage values obtained by sensing the respective voltages of the batteries in a second mode to the charging circuit, and relay a third voltage value of a battery selected by at least one processor from among respective third voltage values obtained by sensing the respective voltages of the batteries in a third mode to the charging circuit, and at least one processor, comprising processing circuitry, individually and/or collectively, configured to: based on respective initial voltage values, obtained by the first circuit, of the batteries exceeding the first threshold voltage value, control the first circuit to operate in the second mode, determine whether the batteries are fully charged, based on some of the batteries not being fully charged, select one of battery that is not fully charged, and control the first circuit to operate in a third mode.

According to various example embodiments, the first circuit may be configured to operate in the first mode based on one or more of the respective initial voltage values being less than or equal to the first threshold voltage value.

According to various example embodiments, based on receiving a maximum voltage value from the first circuit operating in the second mode, the charging circuit may be configured to: determine a first charging current value (e.g., the charging current value₂ described with reference to FIG. 3) based on the maximum voltage value and charge the batteries in a first charging mode, based on the determined first charging current value.

According to various example embodiments, the charging circuit may be configured to: periodically receive a maximum voltage value among respective voltage values of the batteries charged in the first charging mode from the first circuit, and, based on the maximum voltage value received at a first timepoint being greater than or equal to a second threshold voltage value, charge the batteries in a second charging mode.

According to various example embodiments, the first charging mode may include a constant current charging mode and the second charging mode may include a constant voltage charging mode.

According to various example embodiments, at least one processor, individually and/or collectively, may be configured to: acquire state information of the batteries that are not fully charged and select one of the batteries that are not fully charged using the acquired state information.

According to various example embodiments, the first circuit may include a first multiplexer configured to: receive the respective first voltage values of as an input in the first mode, receive the respective second voltage values as an input in the second mode, and receive the respective third voltage values as an input in the third mode, a first comparator configured to: compare the respective first voltage values with one another in the first mode and output a first state value corresponding to a first battery having a minimum voltage value among the respective first voltage values, a second comparator configured to compare the respective second voltage values with one another in the second mode and output a second state value corresponding to a second battery having the maximum voltage value among the respective second voltage values, and a second multiplexer configured to receive the first state value from the first comparator in the first mode, receive the second state value from the second comparator in the second mode, receive a third state value corresponding to the selected battery from at least one processor in the third mode, and output the first to third state values respectively in the first to third modes to the first multiplexer.

According to various example embodiments, the first multiplexer may be configured to: relay the first voltage value of the first battery to the charging circuit, based on the first state value, in the first mode, relay the second voltage value of the second battery to the charging circuit, based on the second state value, in the second mode, and relay the third voltage value of the selected battery to the charging circuit in the third mode.

According to various example embodiments, the first circuit may be configured to: relay the first control signal to the second multiplexer to operate in the first mode based on one or more of the respective initial voltage values being less than or equal to the first threshold voltage value.

According to various example embodiments, at least one processor, individually and/or collectively, is configured to: based on the respective initial voltage values exceeding the first threshold voltage value, relay a second control signal to the second multiplexer such that the first circuit operates in the second mode, and, based on one of the batteries that are not fully charged being selected, relay a third control signal to the second multiplexer such that the first circuit operates in the third mode.

According to various example embodiments, at least one processor, individually and/or collectively, may be configured to: identify whether there is a battery that requires recharging among the batteries after the charging is terminated, and, based on there being a battery that requires recharging, control the first circuit to relay a fourth voltage value of the battery that requires recharging among the respective fourth voltage values obtained by sensing the respective voltages of the batteries in the third mode to the charging circuit.

According to various example embodiments, a method of operating an electronic device may include: based on respective first voltage values, obtained by a first circuit, of plural batteries exceeding a first threshold voltage value, controlling the first circuit such that the first circuit relays a maximum voltage value among the respective first voltage values of the batteries to a charging circuit, determining whether the batteries are fully charged, based on some of the batteries not being fully charged, selecting one of the batteries that are not fully charged from among the batteries, and controlling the first circuit such that the first circuit relays a second voltage value of the selected battery among respective second voltage values, obtained by the first circuit, of the batteries to the charging circuit.

According to various example embodiments, the method of operating the electronic device may include: based on the respective initial voltage values of the batteries obtained by the first circuit in the electronic device exceeding the first threshold voltage value, controlling the first circuit to operate in a second mode among a first mode, the second mode, and a third mode, determining whether the batteries are fully charged, and, based on some of the batteries not being fully charged, selecting one of the batteries that are not fully charged and controlling the first circuit to operate in the third mode.

Based on one or more of the respective initial voltage values being less than or equal to the first threshold voltage value, the first circuit may be configured to operate in the first mode and, in the first mode, may relay a minimum voltage value among respective first voltage values obtained by sensing respective voltages of the batteries to the charging circuit.

In the second mode, the first circuit may be configured to relay a maximum voltage value among respective second voltage values obtained by sensing the respective voltages of the batteries to the charging circuit.

In the third mode, the first circuit may be configured to relay a third voltage value of a battery selected by at least one processor from among third voltage values obtained by sensing the respective voltages of the batteries to the charging circuit.

The method of operating the electronic device may further include: determining a first charging current value based on the maximum voltage value and charging the batteries in a first charging mode, based on the determined first charging current value.

The method of operating the electronic device may further include: periodically obtaining a maximum voltage value among respective voltage values of the batteries charged in the first charging mode, and, based on the maximum voltage value obtained at a first timepoint being greater than or equal to a second threshold voltage value, charging the batteries in a second charging mode.

The method of operating the electronic device may further include: acquiring state information of the batteries that are not fully charged and selecting one of the batteries that are not fully charged using the acquired state information.

The method of operating the electronic device may further include: identifying whether there is a battery that requires recharging among the batteries after charging of the batteries is terminated and, based on there being a battery that requires recharging, controlling the first circuit to relay a fourth voltage value of the battery that requires recharging among respective fourth voltage values obtained by sensing the respective voltages of the batteries in the third mode to the charging circuit.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a plurality of batteries;
a charging circuit configured to charge the batteries;
a first circuit configured to: sense a voltage of each of the batteries, obtain respective voltage values of the batteries and relay one of the obtained voltage values to the charging circuit; and
at least one processor, comprising processing circuitry, individually and/or collectively, configured to: control the first circuit,
based on respective first voltage values, obtained by the first circuit, of the batteries exceeding a first threshold voltage value, control the first circuit to relay a maximum voltage value among the respective first voltage values of the batteries to the charging circuit, determine whether the batteries are fully charged, based on some of the batteries not being fully charged, select one of the batteries that are not fully charged, and control the first circuit to relay a second voltage value of the selected battery among respective second voltage values, obtained by the first circuit, of the batteries to the charging circuit, wherein
the charging circuit is further configured to:
determine a first charging current value based on the maximum voltage value and charge the batteries in a first charging mode, based on the determined first charging current value.

2. The electronic device of claim 1, wherein the charging circuit is further configured to:
periodically receive the maximum voltage value among respective voltage values of the batteries charged in the first charging mode from the first circuit, and, based on the maximum voltage value received at a first timepoint being greater than or equal to a second threshold voltage value, charge the batteries in a second charging mode.

3. The electronic device of claim 2, wherein
the first charging mode includes a constant current charging mode, and
the second charging mode includes a constant voltage charging mode.

4. The electronic device of claim 1, wherein at least one processor,
individually and/or collectively, is configured to
acquire state information of the batteries that are not fully charged and select one of the batteries that are not fully charged using the acquired state information.

5. The electronic device of claim 1, wherein the first circuit comprises:
a first multiplexer configured to: receive respective third voltage values of the batteries as an input in a first mode, receive the respective first voltage values as an input in a second mode, and receive the respective second voltage values as an input in a third mode;
a first comparator configured to compare the respective third voltage values with one another in the first mode and output a first state value corresponding to a first battery having a minimum voltage value among the respective third voltage values;
a second comparator configured to compare the respective first voltage values with one another in the second mode and output a second state value corresponding to a second battery having the maximum voltage value among the respective first voltage values; and
a second multiplexer configured to: receive the first state value from the first comparator in the first mode, receive the second state value from the second comparator in the second mode, receive a third state value corresponding to the selected battery from at least one processor in the third mode, and output the first to third state values respectively in the first to third modes to the first multiplexer.

6. The electronic device of claim 5, wherein the first multiplexer is further configured to:
relay the third voltage value of the first battery to the charging circuit, based on the first state value, in the first mode, relay the first voltage value of the second battery to the charging circuit, based on the second state value, in the second mode, and relay the second voltage value of the selected battery to the charging circuit in the third mode.

7. The electronic device of claim 5, wherein the first circuit is further configured to:
determine whether the respective first voltage values of the batteries exceed the first threshold voltage value, and, based on one or more of the respective first voltage values of the batteries being less than or equal to the first threshold voltage value, relay a first control signal to the second multiplexer to operate in the first mode.

8. The electronic device of claim 5, wherein at least one processor, individually and/or collectively, is configured to:
based on the respective first voltage values of the batteries exceeding the first threshold voltage value, relay a second control signal to the second multiplexer such that the first circuit operates in the second mode, and, based on one of the batteries not fully charged being selected, relay a third control signal to the second multiplexer such that the first circuit operates in the third mode.

9. The electronic device of claim 1, wherein
the first circuit is further configured to: obtain respective fourth voltage values of the batteries after charging of the batteries is terminated, and at least one processor, individually and/or collectively is configured to:
identify whether there is a battery that requires recharging among the batteries after the charging is terminated, and, based on there being a battery that requires recharging, control the first circuit to relay a fourth voltage value of the battery that requires recharging among the respective fourth voltage values of the batteries to the charging circuit.

10. The electronic device of claim 1, wherein,
based on one or more of the respective first voltage values of the batteries being less than or equal to the first threshold voltage value, the charging circuit is configured to charge the batteries based on a second charging current value, and
the first circuit is configured to: select a minimum voltage value from among respective voltage values of the batteries charged based on the second charging current value, determine whether the selected minimum voltage value exceeds the first threshold voltage value, and, based on the selected minimum voltage value exceeding the first threshold voltage value, switch an operation mode from an operation mode for selecting the minimum voltage value to an operation mode for selecting a maximum voltage value of the respective voltage values of the batteries.

11. A method of operating an electronic device, the method comprising:
based on respective initial voltage values of batteries obtained by a first circuit in the electronic device exceeding a first threshold voltage value, controlling the first circuit to operate in a second mode among a first mode, the second mode, and a third mode;
determining whether the batteries are fully charged; and, based on some of the batteries not being fully charged, selecting one of the batteries that are not fully charged and controlling the first circuit to operate in the third mode, wherein,
based on one or more of the respective initial voltage values being less than or equal to the first threshold voltage value, the first circuit is configured to operate in the first mode, and, in the first mode, the first circuit is configured to relay a minimum voltage value among respective first voltage values obtained by sensing respective voltages of the batteries to a charging circuit,
in the second mode, the first circuit is configured to relay a maximum voltage value among respective second voltage values obtained by sensing the respective voltages of the batteries to the charging circuit, and
in the third mode, the first circuit is configured to relay a third voltage value of a battery selected by at least one processor from among third voltage values obtained by sensing the respective voltages of the batteries to the charging circuit.

12. The method of claim 11, further comprising:
determining a first charging current value based on the maximum voltage value and charging the batteries in a first charging mode, based on the determined first charging current value.

13. The method of claim 12, further comprising:
periodically obtaining a maximum voltage value among respective voltage values of the batteries charged in the first charging mode, and, based on the maximum voltage value obtained at a first timepoint being greater than or equal to a second threshold voltage value, charging the batteries in a second charging mode.

14. The method of claim 11, further comprising:
acquiring state information of the batteries that are not fully charged and selecting one of the batteries that are not fully charged using the acquired state information.

15. The method of claim 11, further comprising:
identifying whether there is a battery that requires recharging among the batteries after charging of the batteries is terminated; and,
based on there being a battery that requires recharging, controlling the first circuit to relay a fourth voltage value of the battery that requires recharging among respective fourth voltage values obtained by sensing the respective voltages of the batteries in the third mode to the charging circuit.
